(19) United States
(12) Patent Application Publication
(10) Pub. No.: US 2005/0173380 A1
(43) Pub. Date: Aug. 11, 2005

(54) Directed energy net shape method and apparatus

(76) Inventor: Frank L. Carbone, Dallas County, TX (US)

Correspondence Address: W. THOMAS TIMMONS;THE WHITE HOUSE ON TURTLE CREEK, 2401 TURTLE CREEK BLVD, DALLAS, TX, 75219-4760, US

(21) Appl. No.: 11/054,770

(22) Filed: Feb. 9, 2005

Related U.S. Application Data
(60) Provisional application No. 60/542,962, filed on Feb. 9, 2004.

(51) Int. Cl. B23K 15/00; B23K 26/08

(52) U.S. Cl. 219/121.31; 219/121.82

(57) ABSTRACT

An electron gun mounted on top of a vacuum chamber, the gun emitting an electron beam vertically downward towards a substrate placed upon a three axis movable stage, creating a molten pool on the substrate, which is translated along an automatically generated, pre-programmed path in a plane normal to the beam by an automated numerical controller. A wire feeder and spool surround the beam in an annular ring, providing continuous material feed and constant orientation of the wire to the beam and pool, producing a high rate of material deposition and near net shape geometry. Integrated machining and inspection heads sequentially machine each layer to net shape then non-destructively inspect each layer. A heat and microstructure management system employs chilled oil or liquid metal coolant circulating through a vat surrounding the movable stage, supported by an actuator that gradually submerges the substrate as the deposited layers grow, the circulating coolant removing heat and machine chips. An integrated system architecture including six subsystems ensures density (no voids), accuracy, reliability, repeatability and verifiability: an energy management system manages energy input, including beam density, diameter and position; a geometry acquisition and path planning system acquires the cross-sectional two dimensional geometry from a three dimensional computer generated mathematical model and computes numerical control paths for deposit, machining and inspection processes; a material deposition system controls the placement and rate of material deposited; an integrated machining system subtracts excess material from each layer; an inspection and repair system detects, removes, refills and remachines defective areas; a heat management system eliminates excess heat by controlling the temperature and flow of a liquid metal coolant, and improves the microstructure of the deposited material via transducer generated sonic frequencies; a supervisory control synchronizes and coordinates the interaction between the various subsystems.

### CROSS-REFERENCE TO RELATED APPLICATIONS

Provisional Patent Application Ser. No. 60/542,962, filed Feb. 9, 2004

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to the manufacture of three dimensional objects.

2. Description of Related Art

The ultimate goal of all directed energy metal deposition (DEMD) processes and equipment is to develop faster and more cost effective methods of manufacturing non-prismatic three dimensional components, particularly those of high value due to the fact(s) that they are made of exotic and expensive alloys, are complexly shaped, and have high volume to weight ratios. These parts are commonly built today by one of three processes—casting, forging, or rolling. All three process have two important characteristics which render them vulnerable to replacement by DEMD: they are batch/subtractive processes. A batch process is one in which all of the material necessary to make a component is heated to a molten or plastic state, then poured into castings, shaped into forgings or rolled into billets. The resultant form is then brought to its final configuration by a series of subtraction methods (mainly machining), which brings the part geometry into conformance with prescribed dimensional tolerances and surface finish specifications.

DEMD by contrast, is a selective, additive process. In other words, the material required is discretely melted and added incrementally, and only where it is needed. Hence, there is a dramatic reduction, potentially by as much as an order of magnitude, in the consumption of energy, material and time required for manufacturing. Also, no molds or dies are required, which significantly reduces the non-recurring costs and lead times. This factor is especially significant in the case of low volume production environments such as one finds in the aerospace and defense industry, for example, where many of the requirements (and much of the funding) for this technology reside.

In spite of the promise of dramatic reductions in both recurring costs (time, material and energy) and non-recurring cost (tooling) and having been in development for twenty years, DEMD has not been able to displace existing processes such as forging and casting, even in the most vulnerable applications. There are five obstacles contributing to this impasse, both technical and economic. Technically, the state of the art of DEMD systems has two major limitations: 1) the desired geometry and surface finishes cannot be achieved directly from deposited metal; 2) quality of the fusion, and particularly the absence of voids, cannot be assured. Adding to the technological challenges are three economic disadvantages to current DEMD processes: 1) deposition rates are too low to make the processes economically competitive; 2) the feedstock (typically powder) is expensive to produce, and much of it gets wasted; 3) the deposited material still requires expensive post-deposit machining.

The current Directed Energy Net Shape (DENShape) invention overcomes all of the economic and technical barriers to the commercialization of DEMD and will enable the replacement of forging, casting and machining as the preferred processes for the manufacture of high value metal structure.

Rapid Prototyping (RP) has been in development since the early 1980's. The technology involves the creation of three dimensional (3D) objects by the sequential manufacture of two dimensional cross sectional layers made from the interaction of a directed energy source (laser or electron beam, typically) and a feedstock material (liquid, powder or wire, typically). As some of its other appellations imply (e.g., direct manufacturing or solid free-form fabrication), RP has the advantage of quickly producing 3D objects directly from one of numerous commercially available computer aided design (CAD) solid modeling software programs, thereby eliminating the time-consuming step of building patterns, dies and molds.

Perhaps the most successful and well-known commercially available RP system, described initially in 1986 and subsequently by Hull (U.S. Pat. No. 4,575,330 and U.S. Pat. No. 4,929,402) and commonly known today as sterolithography, employs a low-power numerically controlled laser that sequentially scans the surface of a vat of liquid photosensitive polymer, using rasterized cross-sectional data developed by computer algorithms from a series of “slices” taken perpendicularly to the build axis from a CAD model. The result is a hardened plastic prototype that closely approximates the form and dimensions of the design model. The main commercial limitation to this technology is that the parts made are typically non-functional, especially when the desired components are designed for structural or mechanical purposes and require high strength, temperature resistance, and/or fracture toughness.

By 1989 rapid prototyping had evolved to the manufacture of metal components. More powerful lasers were employed, interacting with a slurry of metal powder in a fluidized bed, by Arcella (U.S. Pat. No. 4,818,562) or directly with a bed of powder, by Deckard, (U.S. Pat. No. 4,863,538), in a process known as laser sintering. These processes are able to product parts that approximate the material properties of cast metal, although persistent voiding remains a problem to this day. The limitations of these processes are that deposition rates are low and are not void-free, surface finishes are rougher than are typically desired, and build-ups are limited to part profiles that do not include negative draft angles.

Since then, deposition rates have been improved by using more powerful lasers or plasma beams attached to a robot and injecting powdered metal carried by an inert gas into the molten pool. These processes also enable parts to be manufactured with negative draft angles, because the material can be delivered from a non-orthogonal direction. However, these processes still do not result in parts with accurate dimensions or good surface finishes (i.e., net shape), and most detrimentally, still have a tendency to produce deleterious voids and generally lack the desired material properties (e.g., strength, ductility, fracture toughness) consistent with their cast or forged counterparts.

In 1993, Schneebeli (U.S. Pat. No. 5,233,150) described a welding system that employs a multiaxis robot and multiaxis positioning system, an electric arc (MIG welding) energy source and a fixed orientation wire feed material source. This combination results in a layered buildup that produces less voids and higher deposition rates. Its limitations are that the requirement for multiple multiaxis synchronicity between the fixturing system and the robotic welding system diminishes repeatability and reliability, and therefore produces less accurate “not-so-near-net” shapes. Metallurgically, the open air environment introduces oxidation products which are largely deleterious in structural environments; and MIG welding produces a large heat affected zone (HAZ), causing (undesirable) non-uniform microstructure. The invention also has no provisions for managing the heat input or removal, which are both essential for the development of consistent metallurgy and microstructure. Most importantly, MIG welding in general affords little potential for automated control of the energy and mass transfer dynamics necessary for molten pool stability, because the only process variable available for control is the arc current. Compare that to the physics of the electron beam (the preferred embodiment of the current invention), which enable the control of beam penetration, focus, shape, position, energy density, and cycling, all instantaneously and simultaneously. None of the other energy sources used in RP have even half that control ability.

In 1996, Rabinovich (U.S. Pat. No. 5,578,227) proposed a rapid prototyping system that employs a laser and wire feed system that enables the wire feed to remain at a constant orientation angle to the direction of deposit, thereby enabling a deposition process that is more accurate and that he claims is nearer to net shape than previous systems. Undoubtedly this is an improvement over the accuracy of other previous wire feed systems (e.g., Brown et al, U.S. Pat. No. 4,323,756), but it is doubtful that it would be more accurate than stereolithography, whose resolution is the width of the laser, whereas Rabinovich's resolution is limited to the minimum diameter of his wire. Additionally, as with any of the systems previously mentioned, the finer the resolution required, the slower the build process. Rabinovich's most recent patent (U.S. Pat. No. 6,459,069) incorporates a second wire feed to deposit layers of alternating materiel, and a mill head to smooth lateral and upper surfaces. It is designed as a production system to build multiple thinly layered composite parts.

Although this latter patent incorporates some additional features that advance towards a production system, and may be suitable to manufacturing lightweight composite structure, it lacks some of the critical capabilities necessary for an industrially hardened process capable of replacing forged and cast components, which the current invention does. Namely, the Rabinovich's design lacks the rigidity to remove material in anything other that a surface smoothing mode, as Rabinovich represents the milling head's intended use. The entire design is suspended and presupposes a C-frame construction that limits its ability to be further stiffened. Secondly, Rabinovich's invention does not allow for the use of multiple metal removal tools or multiaxis tool orientation necessary for the finish machining of most complex structural components (he describes a millhead that can be angled, but shows a mill head that is fixed—an angled milling capability requires much more mechanical, structural and control features, and the attendant space—than his invention provides or affords). Thirdly, Rabinovich's invention does not provide for heat management and microstructure control as the current invention does (not unsurprisingly, since his machine was not intended to melt the volumes of metal typically required for forgings and castings).

Another design, by Prinz (U.S. Pat. No. 5,207,371 envisions a welding head attached to a CNC milling machine (as opposed to integrating a milling apparatus into a deposition machine). Although better capable of metal removal tasks than Rabinovich's invention, since it is essentially a mill, Prinz' design is simplistic and commercially impractical: it does not provide a means for automating the metal deposition process; the use of “complementary material” for overhangs (i.e., negative draft angled profiles) is both time consuming and wasteful; the use of specially ground milling cutters for machining underneath overhangs is both expensive and impractical, because periphery draft angles often change, even within the same layer. Metallurgically, Prinz does not provide for any energy or heat management or microstructural control. Prinz also optimistically assumes that fusion will be perfect just because he is using a welding wire process instead of a metal powder process. Much subsequent research has been done to monitor and control the transfer of mass and energy to the molten pool of automated deposition processes; such research has established that feedback control and regulation of the energy input and sinking of excess heat buildup is essential for process stability and consistent deposition and metallurgical quality. As is the case with Schneebeli's patent, Prinz' use of a conventional welding head has the same limitations for beam control.

As previously stated, the current invention uses an electron beam in the preferred embodiment. Adler (U.S. Pat. No. 6,537,052) cites the advantages of electron beams over other energy sources in his invention of a high speed rapid prototyping system for plastic components. Adler takes advantage of EB's controllability and penetrability in achieving to achieve solidification 40 times that capable of sterolithography, as described by Hull (previously cited). Adler takes advantage of EB's ability to be manipulated electronically, via electromagnetic focusing and deflection lenses that can oscillate the beam's size, shape, position, penetration and density hundreds of times per second. Lasers, by contrast, need to rely upon cumbersome and relatively slow mechanical devices for beam control and phase transformations for energy requirements to achieve even a modicum of EB's beam parameter control. For example, an EB can change its focus instantaneously and continuously merely by minutely varying (by a few milliamps) the voltage in its focusing coils; lasers must use specially ground Cassegranian focusing optics, as described by Mazumder et al (U.S. Pat. No. 6,710,280) in order to change the focal length of a laser. Changing the position of the beam focus point, or shape of the beam, or beam energy density, or beam penetrability constitute equally challenging problems using laser physics, and trying to change multiple parameters simultaneously, much less all of parameters cited above (which is currently standard on most EB manufacturers' equipment—in spite of Maxumder's claims to the contrary), is not part of the current body of art and therefore currently impossible. Differentiating the current invention from Maxunder et al's invention, their claims for high speed rapid prototyping do not apply to metal components, and his invention does not provide for use of wire feed stock or provide for interactive machining to improve dimensional accuracy and surface finishes.

The vast majority of RP systems targeting metal components today use powder as the feedstock, because it is relatively easy to control and can be melted by the low power systems typically found in research environments. However, powder has five serious drawbacks, four economical and one technical: Economically, 1) Powder is expensive to manufacture; 2) Powder requires an expensive inert carrier gas; 3) Powder cannot be deposited in very high volumes 4) A significant portion of powder is wasted in the process (up to 50%, depending on the process particulars). Technically, powder has a tendency to produce voids and incomplete melting, especially on the fringes of the molten pool. Wire, by contrast, is cheaper to produce, requires no carrier gas, and produces virtually no waste. Technically, powder does not fuse as reliably as wire, because some of the powder is melted at the fringe of the molten pool, and is potentially incompletely melted before solidification takes place. It also produces more voids due to its larger surface area. Wire, by contrast, can be directed to the center of the molten pool, thereby ensuring its complete fusion. If the wire doesn't melt, it becomes very obvious—the wire becomes “stuck” and the wire feeder stops.

Heat management and microstructural control are important aspects of this technology if it is ever to be competitive with current production methods, especially forging and casting. This subject has been largely ignored in RP literature because larger challenges loom, such as void creation and detection, slow deposition rates and geometrical inaccuracy. Nonetheless, heat management and microstructural control absolutely must be addressed if these technologies are to enter mainstream manufacturing. Heat management becomes more of an issue as the number of deposited layers increases and the molten pool gets further away from the substrate and underlying platen (typically copper, if employed) which acts as a heat sink. None of the inventions previously cited provide for a mechanism to extract excess heat or proactively control microstructure, although some of the concepts and techniques used in the current invention have been used in other applications. The current invention uses either a internally cooled platen or a liquid metal coolant bath of proprietary composition. Such baths have been employed in the manufacture of directionally solidified castings (U.S. Pat. No. 6,715,534). The current invention applies similar techniques, but because the current invention enables more discrete (layer-by-layer) cooling capabilities, we employ more proactive and sensitive temperature control of the liquid metal coolant, and maintain more direct contact with both the interior and exterior of the solidifying material.

Another device employed in the current invention that further controls microstructure via ultrasonic frequencies is a transducer. This technique has been employed to stress relieve welded structures (U.S. Pat. No. 6,843,957). The current invention uses transducers similarly, but immerses the transducer(s) in the liquid metal bath, thereby producing a combined and synergistic effect, because the liquid metal bath can maintain a prescribed temperature and deliver a uniform frequency to the deposited material.

Metal parts produced by deposition process have microstructures and material properties that approach those of cast components. However, many structural components have material properties with greater strength requirements, and a microstructure more consistent with forging. The metal deposition process, combined with localized compressive force applied during the solidification process, can yield improved strength and microstructure that approaches that of forged components, as demonstrated by Siedal (U.S. Pat. No. 6,710,296). Siedal's process is limited in deposition paths that are uni-directional and therefore limited to simplistic designs. The current invention improves on this process by providing a roller that can be fitted in the spindle, and oriented in accordance with to the direction of the deposited bead, thereby allowing any orientations to be achieved.

Finally, and perhaps most importantly, none of the current processes have the ability to produce void-free metal components. This is the single most severe impediment to commercialization of DEMD technologies. The current DENShape process assures void-free deposition in three ways, employing two innovative processes. Firstly, the current process, in the preferred embodiment, employs the optimal combination of energy sources and feedstock for maximum deposit quality, namely electron beam and wire feed. This energy source/feed stock combination has three advantages over those employed by other DEMD systems: a) electron beams, due to their ability to be precisely controlled and penetrate deeply while maintaining a narrow heat affected zone, have been successfully used in industry to perform precision, deep penetration welding in high stress, fracture critical environments for over 50 years; b) wire fed deposits are far less likely to include voids than powder-fed systems because with wire is rigid and has a constant diameter, assuring constant and targeted mass transfer to the molten pool; powder particles do not have uniform size, are dispensed with a carrier gas that is susceptible to pressure fluctuations, and are delivered in a dispersive pattern that causes some of the powder to be incompletely melting and fused on the periphery of the molten pool; c) wire has less than 10% of the surface area of an equivalent amount of powder, thereby greatly reducing the possibility of contamination by oxidation products. Secondly, the current invention employs an energy and mass transfer sensing system that automatically maintains a stable molten pool by making instantaneous, coordinated adjustments to the input energy (beam voltage, current, diameter, shape and position), the wire feed rate, and the rate of cooling (via the regulation of the temperature of the liquid metal coolant bath). Thus, far less voids are produced (probably on the order of 80-90% fewer) that laser/powder systems. Thirdly, (and perhaps most importantly until the process becomes more widely accepted and used commercially), the current invention employs a proactive, layer-by-layer void detection and repair system. This is accomplished by milling off the top of each layer with one of the assortment of cutting tools that can be interactively inserted into the motorized spindle, (thereby exposing hidden voids), scanning the surface of the layer with the electron beam and detecting the backscatter of electrons with a detection device identical to those employed in scanning electron microscopy, recording the position of voids, excising the voids with a second cutting tool, re-depositing material in the area excised, remachining the surface, then re-inspecting before proceeding to the next layer. This process eliminates the much more costly inspection and repair processes required to detect, remove and repair a void once the part is complete.

### BRIEF SUMMARY OF THE INVENTION

The present invention, for which this inventor coins the term Directed Energy Net Shape (DENShape), is a method and apparatus, for the direct manufacture of net shaped, fully dense, metallurgically equivalent structural components currently manufactured by forging, casting, machining, or a combination thereof DENShape uses a directed energy beam generated from one of several sources, including but not limited to electron beams (preferred embodiment), lasers, and various welding and torching devices, in the form of a controlled, high energy density, focused beam (see “Energy Management System”, below) to produce a heated area on a substrate, (typically metallic, for the commercial applications identified herein), thereby creating a molten pool. The energy source and/or the substrate base may be translated in relation to one another along multiple synchronously controlled axes of motion, via commercially available hardware. The preferred embodiment includes a three axis stage and controller capable of accommodating two additional rotational axes as in a rotating and tilting table. All five stage motion axes are independently and synchronously controlled via industry standard CNC controllers, drives motors and servos, in such a way as to trace a path prescribed by a sequential series of two dimensional cross-sections derived from a three dimensional computer generated mathematical model of a component, as described in “Geometry Acquisition and Path Planning” (GAPP) below. Motion control may be achieved by various combinations of independently controlled axis attached to either the energy source or the work piece fixture (i.e., the energy source can move, the work piece can move, or both). The preferred embodiment provides for a fixed beam with all of the motion control at the fixture. This provides a common platform for machining and inspection operations, as described below.

Material, typically in the form of powder or wire, is added to the molten pool in a controlled fashion as described in “Material Deposition System” (MDS) below. The wire delivery spool (preferred embodiment) is concentric and surrounding a motorized spindle, which is itself concentric with and surrounding the beam axis (interior to the wire spool). The wire spool is driven by the spindle when engaged via a pneumatic or electromagnetic clutch, which allows the wire orientation angle to be maintained at a constant angle to the deposition motion vector. The added material instantaneously melts upon contact with the energy beam and the molten pool. The molten pool quickly solidifies as the energy beam and/or the substrate continues to move, leaving behind a raised mound in the path of the beam, with the general appearance and shape of a welded bead. On any given layer, one or more of a series of parallel overlapping beads may be deposited, depending upon the thickness of the individual beads, the programmed bead overlap and the cross-section thickness of the layer being deposited, dictated by GAPP. The interim result is a “near-net” cross sectional shape, with an excess of approximately 0.050″ on each lateral surface and 0.025″ on the top surface.

After the near-net shape of each layer is established, the final configuration is established under the control of the Integrated Machining System (IMS). In the preferred embodiment, the IMS consists of a motorized spindle concentric with the beam axis, a series of tools in a tool holder ring, or carousel, concentric with and exterior to the spindle, but interior to the wire spool, and an automated tool changer that takes and replaces tools from the tool carousel to and from the spindle. The beam is temporarily deactivated while the milling head removes excess material from the width and height of the just-deposited layer, rendering a net shape (±0.005″) for that layer. For parts without draft angles, a three axis stage is adequate. For more complex parts requiring a 180 degree sphere of vector orientation, motion control is achieved through the five axes previously described. In an alternative configuration, without the rotating/tilting table, the XY work plate is configured as a “window frame” that can be flipped 180° to deposit on both sides of the part. Once the net shape is established for a given layer, the cutting tool is removed, allowing for the passage of the energy beam. A Non-Destructive Inspection (NDI) energy source, which may be in the form of an electron beam (the preferred embodiment, in which the electron beam also serves as the energy source for melting the feedstock), Xray, or ultrasound, operating under the control of the “Inspection and Repair System” (IRS) software, then traverses over the top of the just-milled surface to ensure that adequate fusion has taken place between the layers and that no voids have been introduced. Once the inspection process for the layer is complete, the deposition process is then begun on the next layer. In the event that a void or incomplete fusion is detected, a milling tool will be re-inserted into the spindle and a prescribed repair and re-inspect routine will be performed before proceeding to the next layer. The net result is a fully dense, functional, accurate, verifiable and repeatable three-dimensional structure.

For higher production rates, an alternative to the integration of the deposition and milling processes is described, which enables the deposition and milling processes to occur simultaneously rather than sequentially. In this embodiment, a pallet changer of a common variety simultaneously switches two palletized fixtures and parts that are in work at the same time, one being milled while the other is being deposited. The two processes can be tuned so that they each take approximately the same time, so that there is no time lag between sequences. This process obviously requires a much larger chamber (approximately twice as large) to accommodate two parts and simultaneous processes. Another benefit of separating the milling and deposition functions is that the mechanism becomes simpler and more rigid.

Excess heat is removed by a proactive cooling system. For low profile parts, consisting of approximately two to three inches of height, cooling is accomplished vial an internally cooled copper platen. The platen's internal cooling tubes are filled with oil, which is pumped outside of the chamber and the oil is cooled through a heat exchanger using chilled water as the heat sink. For taller parts requiring more direct heat removal, rather that being conducted through the previously deposited layers and the copper platen, a liquid metal coolant bath in employed, as shown in. The liquid metal bath resides in a pool below the platen, and as the platen is lowered to build each successive layer, the liquid metal passes through holes in the platen to surround the part. The liquid metal bath is cooled via an oil-cooled tube in the shape of an Archimedes spiral secured to the bottom of the vat and the underside of the platen. The heat is extracted from the oil as previously described. For further microstructure management of deposited metal, one or more transducers are placed on the platen to provide vibratory stress relief In the case employing the liquid metal bath, the transducer is submerged in the bath and the sound waves are propagated uniformly to the part through the bath. The temperature of the bath, oil, chilled water and application of sonic vibration are all controlled by the Heat and Microstructure Manager (HMM) software. The simultaneous application of sonic vibratory and thermal heat treatments to the deposit provides unique opportunities for synergistic effects and advanced microstructure management.

The interaction of the various subsystems (EMS, GAPP, MDM, IMS, IRS, and HMM) is optimized and stabilized by an automated, closed loop feedback control system, as described in “System Architecture”, below.

These and other objects, advantages and features of this invention will be apparent from the following description taken with reference to the accompanying drawings, wherein is shown a preferred embodiment of the invention.

### BRIEF DESCRIPTION OF THE SEVERAL VIEWS OF THE DRAWING

FIG. 1 is an elevation cross-sectional view of a directed energy net shape apparatus with a single pallet, a three axis motion control system, unidirectional axial growth capability, Heat and Microstructure Management System components with cooling platen with internal cooling chambers and a single integrated EMS, MDS, IMS, IRS head, according to the present invention;

FIG. 2 is an elevation cross-section view of the Heat and Microstructure Management System components with liquid metal bath cooling vat.

FIG. 3 is an elevation view of a directed energy net shape apparatus with dual pallets and independent deposition and machining heads.

FIG. 4 is plan view of the three axis stage and pallet described in FIG. 1 and a typical part geometry capable of being manufactured with said apparatus.

FIG. 5 is a side view of the stage, pallet and part shown in FIG. 4.

FIG. 6 is a plan view of the apparatus described in FIG. 1 with a three axis stage and a pallet capable of being automatically rotated 180° for bi-directional axial deposition and a typical part capable of being manufactured with said apparatus.

FIG. 7 is a side view of the stage, pallet and part shown in FIG. 6.

FIG. 8 is a side view of the apparatus described in FIG. 1 with a three axis stage, with a tilting, rotary table capable of 180° spherical vector motion and a typical part capable of being manufactured with said apparatus.

FIG. 9 is a plan view of the stage, pallet and part shown in FIG. 8.

FIG. 10 is en elevation view of the three axis stage and pallet described in FIG. 1 with a roll tool placed in the spindle, used for localized forging.

FIG. 11 is a first process flow chart for a method according to the present invention, showing the interaction of the various subsystems;

FIG. 12 is a second process flow chart for a method according to the present invention showing the feedback control loops and their interaction between the various subsystems;

FIG. 13 is a third process flow chart for a method according to the present invention showing the interaction of Feedback Loop1 with the Energy/Mass transfer Sensor System and the Supervisory Controller;

FIG. 14 is fourth process flow chart for a method according to the present invention, showing the interaction of the various components of Feedback Loop II and the Inspection and Repair System; and

FIG. 15 is a elevation cross-section view of an alternative embodiment of a directed energy net shape apparatus according to the present invention.

### DETAILED DESCRIPTION OF THE INVENTION

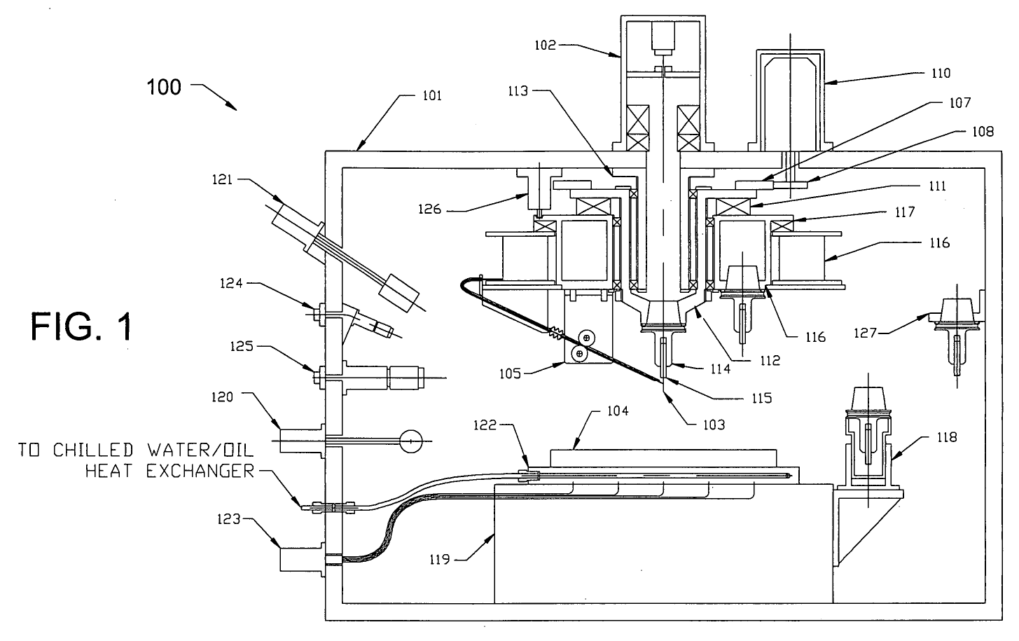

Referring now to the drawing, and in particular to FIG. 1, a directed energy net shape apparatus according to the present invention is referred to generally by reference numeral 100. a directed energy net shape apparatus 100 includes an enclosure (vacuum chamber) 101.

The process requires a leak-free enclosure in order to prevent oxidation during the deposition process. In the case of the preferred embodiment, the energy source is an electron beam (EB), which performs best in a vacuum environment (10⁻⁵ torr) because in a vacuum there is minimal dissipating atmospheric ionization. However, it should be noted that partial vacuums and non-vacuum environments have been used for EB welding by using higher power guns to compensate for the atmospheric dissipation, and since the current invention does not require deep penetration or a very narrow beam, that option is available. However, it should also be noted that higher vacuum produces higher quality metal deposition (i.e., less voids and less oxidation products), and produces more reliable and repeatable deposition than non-vacuum environments that use inert gas to prevent oxidation. For metal powder material delivery systems, the inert gas used to prevent oxidation is also used to carry the (metal) powder to the molten pool. An access door is required for inserting and removing components. For EB systems, the chamber is typically made of ½″ to 1″ thick steel, depending on the size of the chamber. The EB chamber's thick steel also provides the structural rigidity necessary to perform the machining operations. Environmentally, non-vacuum chambers needn't be as thick, as they are not required to resist atmospheric pressure, but still require the rigidity necessary for performing necessary machining operations, and would have to be otherwise strengthened in the areas absorbing metal removal loads.

Energy Management System and Energy Source (Electron Gun) is referred to by reference numeral 102. Numerous energy sources have been used for DEMD, with particular emphasis on lasers. Plasma, arc welders and electron beams have also been used. To be useful in DEMD, the energy source has to have the ability to deliver variable power, typically in the range of 5-50 KW, but scalable depending on requirements. It must deliver the power in a densely focused beam, with a diameter generally ranging from 0.025″ to 0.25″ depending on the desired bead width. The energy source must also have the capability of being controlled in terms of beam power, beam diameter and beam position. The current patent application focuses on EB as the energy source for various reasons, including its superior energy density, efficiency, controllability, and scalability. These features of EB vis-á-vis other mentioned energy sources used in RP are well documented in various welding technology texts. The control of the EB (or other energy source), including all of the individual beam parameters, is computer controlled by the Energy Management System (EMS), which is part of the current invention and described in detail under “System Architecture”, below.

The Electron Beam 103 impinges on a substrate 104, typically a sacrificial metal plate approximately similar in chemical composition to the alloy being deposited, but may be actual material that becomes part of the final deposited component configuration. The beam's energy is absorbed by the material, thereby creating a small molten pool, about the size of the beam's diameter, at the surface of the substrate. The substrate is translated in the plane of deposition by the moveable stage 119. Material is fed into the molten pool by a wire feeder 105 that delivers material to the pool at a variable rate.

Material Deposition System and Device (Wire Feed) is referred to by reference numeral 105. The current invention preferred embodiment of the material feed is a wire feeder. Most of the prior art has focused on powder feeders as the pre-deposit material form, primarily because powder is easier to control and requires less energy to melt. However, as previously discussed, powder has serious drawbacks that are tolerated primarily because of powder's relative ease of use, not its intrinsic abilities in metal deposition.. The current design enables the rapid and accurate orientation, placement, and deposition of wire, a far more reliable material source, as described below.

The current invention's preferred embodiment incorporates a wire feed capable of continuous 360 degree rotation without becoming obstructed or limited or entangled by the wire feed path. This is possible because the wire feed spool 116 is mounted on a carriage 117, both of which are free to rotate about an axis collinear with the axis of the beam; hence, the beam passes through the center of the spool and a corresponding hole in the carriage. The base of the carriage is mounted to a ring gear 107, also concentric to the beam, which is meshed to a drive gear 108 powered by a switchable spindle/servo motor 110. The carriage is clutched 111 to and rotates about the motorized spindle 112 which consists of a cylinder welded to an annular ring, both of whose axes are concentric with the axis of the beam. The spindle mounts to a fixed flanged cylinder attached to the chamber ceiling 113.

The wire feed is maintained at a constant position to the deposition vector and to the molten pool by the MDS system. Two CCD cameras 125 monitor wire-to-puddle positioning from two perpendicular directions only one camera is shown in FIG. 1; the other is directly behind the deposition assembly, mounted to the back wall of the chamber). The MDS makes necessary adjustments to the beam and wire positions via the wire feed controller and the beam controller which adjusts the current in the EB deflection coils). When the wire feed clutch is disengaged, a pin lock 126 is automatically engaged to keep the wire feed and tool carousel assemblies from freewheeling with spindle momentum.

The invention forms an integrated machining system and device. Once the wire is melted into a near net shape layer, the final configuration is established by inserting a toolholder 114 and cutting tool 115 into the spindle 112. The cutting tools are arranged in a tool carousel 116 concentric with the spindle. An alternative or auxiliary tool change rack may be mounted on the side of the chamber 127. A retractable tool changer 118 is a hydraulically or electrically powered telescoping piston that is mounted to the side of the moveable stage 119. The moveable stage is translated as during the deposition process, removing excess material and establishing the net shape deposition, thereby eliminating the need for post deposition machining. Removing the excess material when it is readily accessible and quickly removed greatly simplifies the process, as compared to machining complete castings or forgings, especially large and/or complexly shaped ones. It also enables the ability to accurately create hollow cross sections that cannot otherwise be created. It also reduces the complexity of the machining process to a simple two axis process involving minimal material removal, thereby requiring much less expensive equipment (e.g., a $2,000 router type head versus a $500,000 multiaxis milling machine tool), less set-ups, less time and less potential for error. The finish machining is performed under the control of the Integrated Machining System.

An inspection and repair device: once the net shape is established, the electron beam is operated at a low energy level, insufficient to melt the machined deposit but sufficient enough create backscatter and secondary electron emissions, in a manner much like a scanning electron microscope. A backscatter detector is mounted to the lower left wall of the chamber 120 and a secondary electron detector is mounted to the upper left wall of the chamber 121. The backscatter detector is used to detect voids on the surface of the most recently deposited and milled layer. Similarly, the secondary electron detector can detect voids slightly below the surface. Since the deposited layers are only approximately 0.050-0.-075″ thick, and 0.025″ is milled off, and Auger electrons can be detected 0.010″ to 0.020″ below the surface, it is almost assured that any voids over 0.010″ will be detected. The integration of NDI into the manufacturing process provides many benefits. As previously discussed, casting and forging are batch processes, i.e., the part is made all at once from a single “pour” of metal. This creates a situation where imperfections can get buried in the middle of the casting or forging, rendering the flaws hard to detect and even more difficult (and expensive and time consuming) to repair. Similarly, previous metal deposition systems that don't have integrated machining capabilities also have the potential to introduce flaws. In the current invention, once the flaw is detected, it is quickly excised with the milling head, material is re-deposited, and re-machined and re-inspected. The inspection and repair is performed under the automated control of the Inspection and Repair System (IRS) software, part of the current invention.

Heat sink: all DEMD systems produce a certain amount of excess heat. As the number of deposited layers grows, the heat builds, which weakens the surface tension of the molten pool and negatively effects deposition control. The inability to remove the heat quickly and efficiently also has negative effects on the microstructure and material properties of the deposit. FIG. 1 shows a proactive coolant system comprised of a copper platen with internal cooling channels 122 carrying an oil based coolant. The coolant is circulated outside the chamber and the heat is extracted via an oil/water heat exchanger. The water temperature is maintained by a PID control at the water chiller. A flow regulator regulates the flow of oil. The Heat Management System employs temperature gauges to monitors the temperature of incoming and outgoing oil and water; it employs thermocouples to monitor the temperature of the cooling platen 123 and a bichromatic pyrometer 124 to monitor the temperature of the workpiece. This heat sink is designed for fairly low weight parts that require relatively few layers of deposit.

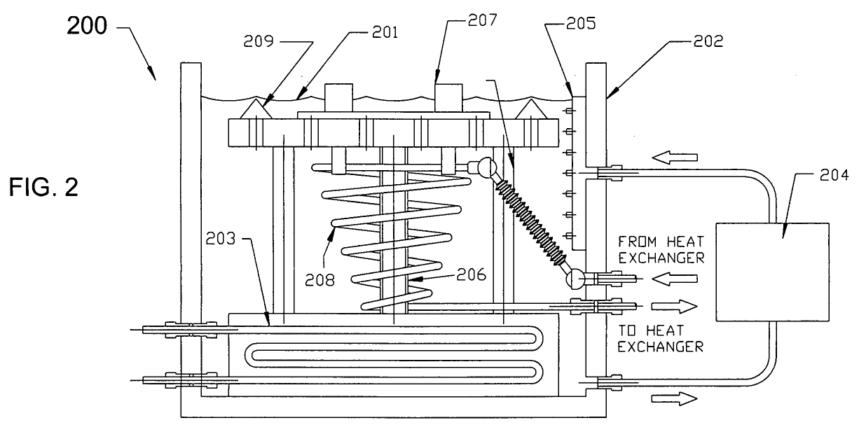

Referring now to FIG. 2, as deposit weight and layer height increase, the cooling platen becomes less efficient in extracting heat, as the heat needs to be conducted through all of the previous layers before being extracted. FIG. 2 shows a second configuration of the HMS, employing a liquid metal coolant (LMC) to conduct heat away from the deposition surfaces. The LMC 201 is an alloy specially developed for this process. It remains in a liquid state over a wide temperature range (approximately 100° C.-1,000° C.). The LMC is contained in a vat 202. A heating element located at the bottom of the vat 203 is used to liquify any solidified LMC. The LMC is pumped from the bottom of the vat (where the heavier, cooler LMC resides) by one or more electromagnetic pumps 204 and dispersed through a manifold 205 throughout the vat. A telescoping Z axis 206 lowers into the LMC, as the part 207 builds, submerging and cooling each successive deposition layer. The LMC is cooled by a cooling coil in the form of an Archimedes spiral 208 flowing with and oil base coolant. The oil is circulated out of the vat and chamber and run through a oil/chilled water heat exchanger (not shown). The HMS regulates the flow of the LMC, oil and chilled water.

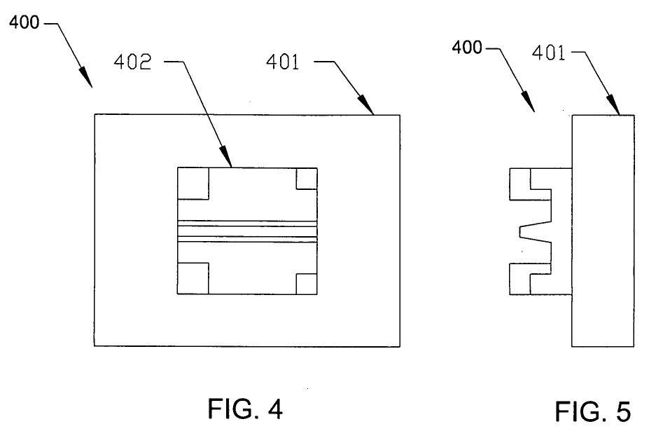

Referring also to FIGS. 4 and 5, FIG. 4 is representative of a plan view of a three axis stage with unidirectional tooling, and cooling platen with internal cooling. This tooling and heat management configuration is useful for parts that are of limited height and number of deposit layers, and for building depositing in one direction only. A typical part configuration is shown. FIG. 5 represents a side view of the tooling and part shown in FIG. 4.

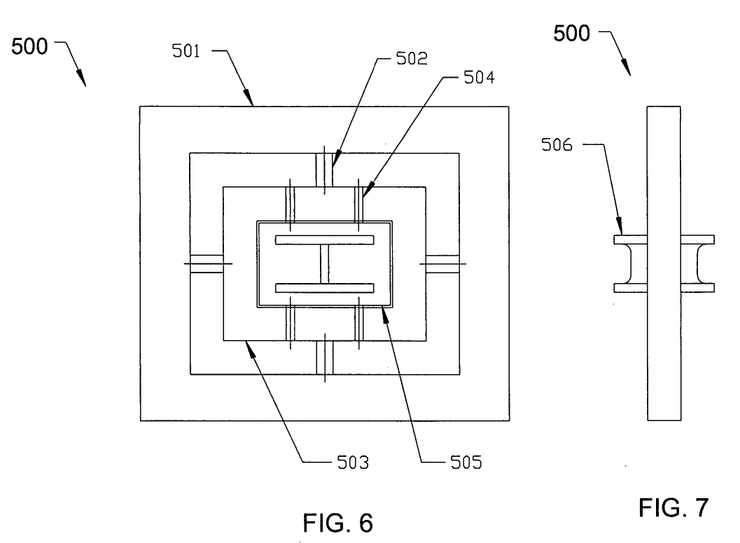

Referring now also to FIGS. 6 and 7, FIG. 6 is representative of a plan view of a three axis stage with bidirectional tooling, a picture frame holding fixture. This tooling configuration is used in conjunction with a LMC heat management configuration as depicted in FIG. 1. This tooling and heat management configuration is useful for parts that require deposition on both sides of a central web. A typical part configuration is shown. FIG. 7 represents a side view of the tooling and part shown in FIG. 6.

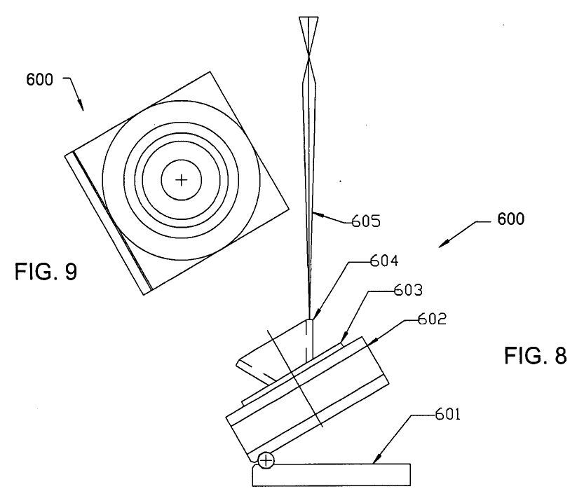

Referring also to FIG. 8 and FIG. 9, FIG. 8 is representative of a plan view of a five axis stage with unidirectional tooling, and cooling platen with internal cooling. This tooling and heat management configuration is useful for parts that are of limited height and number of deposit layers, and for building depositing in one direction only. FIG. 9 represents a plan view of the tooling and part shown in FIG. 8.

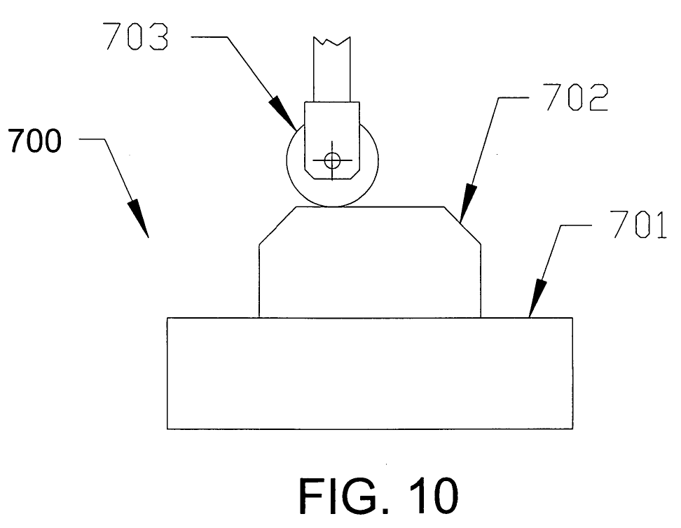

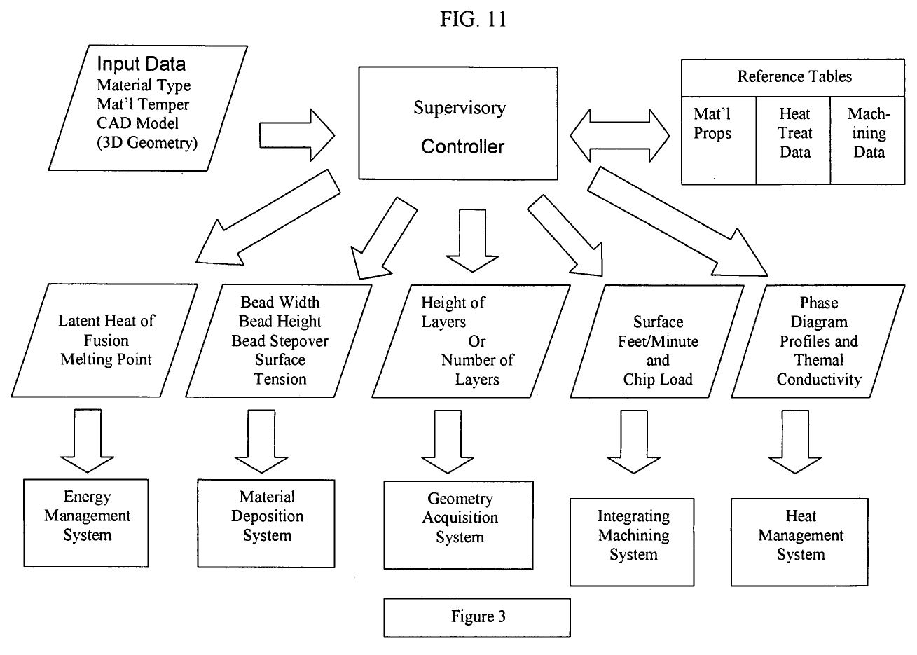

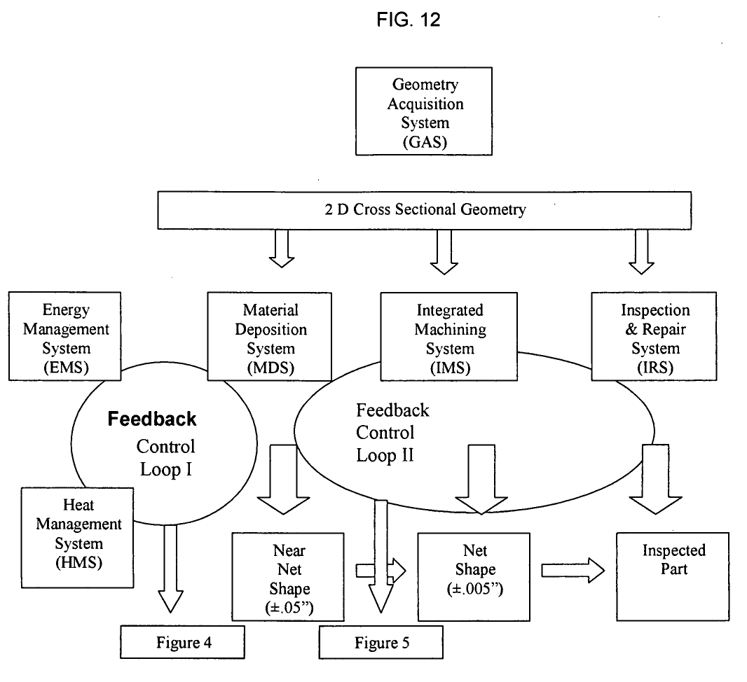

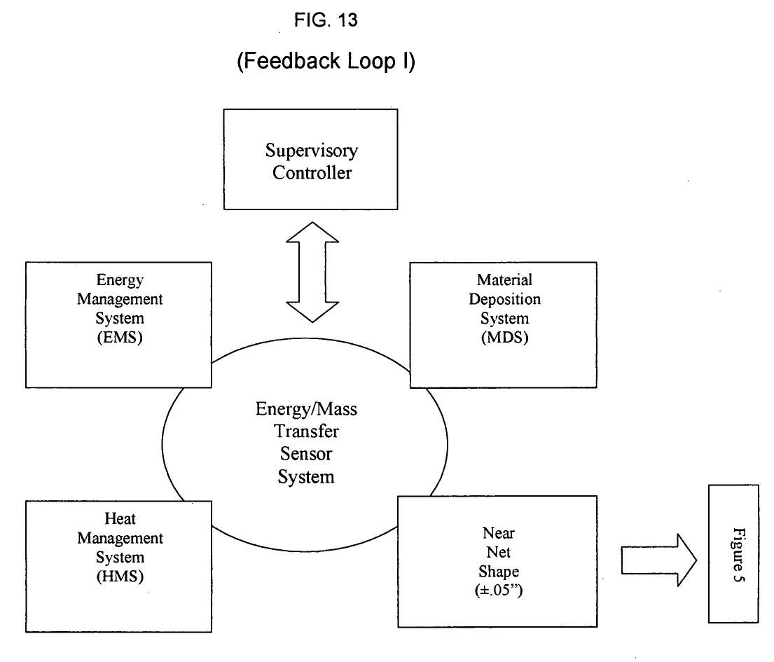

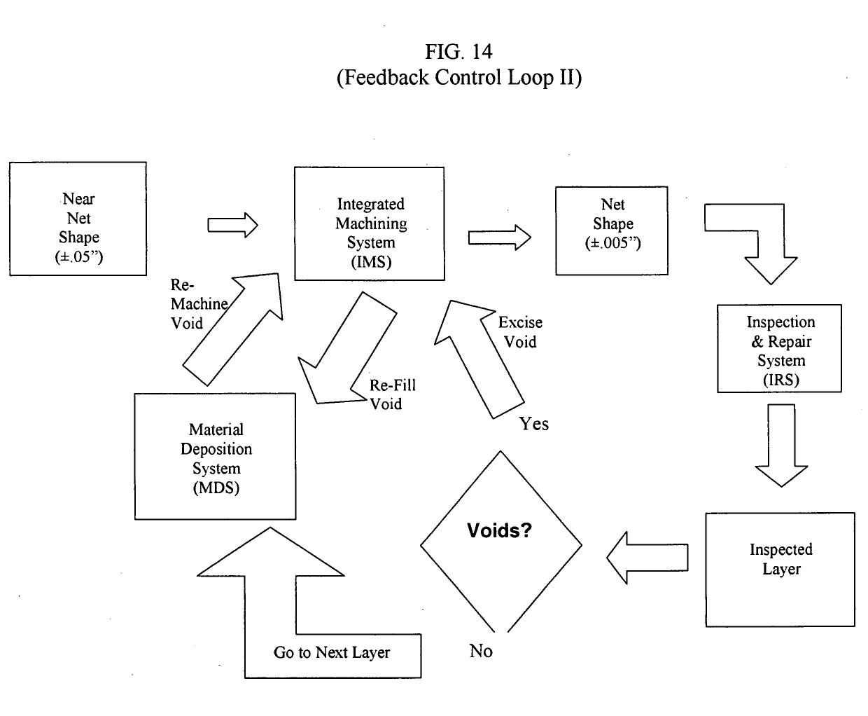

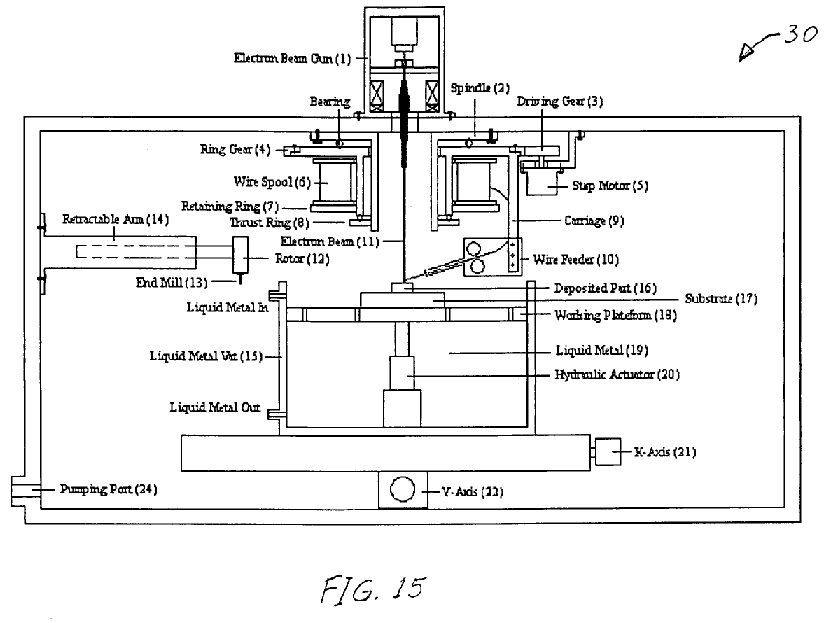

Referring now to FIG. 10, FIG. 10 represents a tooling pallet similar to that shown in any of FIGS. 1, 2, 3, 4, 6, or 8. For localized forging, compressive force is applied in a concentrated fashion using a roller 703 inserted in a tool holder in the tooling carousel, as any other cutting tool might be. The roller is positioned in contact with the recently deposited metal 702. The sides of the roller are maintained parallel to the deposit path through numerically controlled rotation of the switchable spindle/servo motor. The moveable stage's Z axis actuator (or actuators—one at each corner of the moveable stage may be required) applies sufficient force to the deposited geometry forced against the roller tool as to apply compressive force to the deposited material. The deposited material, for the current application, may be maintained at an elevated temperature by the Heat and Microstructure Management Subsystem to simulate typical forging conditions.

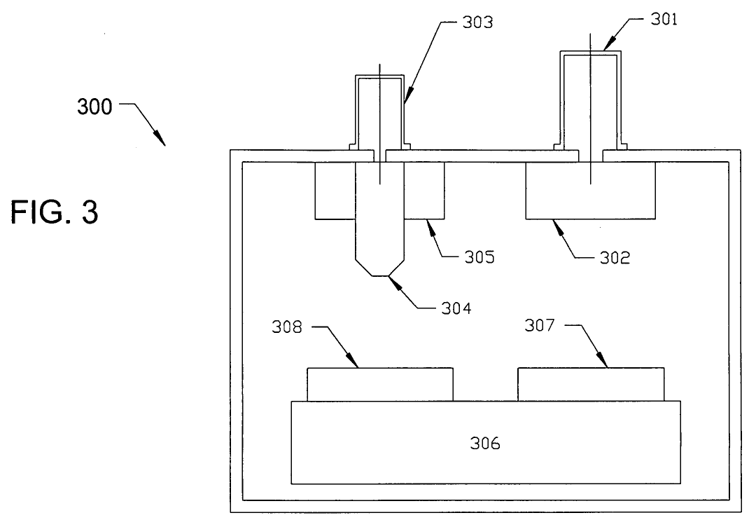

For higher production rates, an alternative to the integration of the deposition and milling processes is described in FIG. 3, which enables the deposition and milling processes to occur simultaneously rather than sequentially. This configuration uses two separate and independently mounted heads. In FIG. 3, the head on the right is comprised of an electron gun 301 and concentrically mounted wire feed unit 302; the head on the left is comprised of a spindle motor 303, spindle 304 and concentric tool carousel 305. A pallet changer 306 of a common variety simultaneously switches two palletized fixtures 307 and 308 by rotating the fixtures and parts 180° (such that referring to the current view, 307 is rotated to the left position and 308 is rotated to the right). The result is that two parts are in work at the same time, one being milled while the other is being deposited. The two processes can be tuned so that they each take approximately the same time, so that there is no time lag between sequences. This process obviously requires a vacuum chamber approximately twice as large. Another benefit of separating the milling and deposition functions is that the mechanism becomes simpler and more rigid.

System Architecture: the previously described innovations offer significant improvements to the DEMD process: improved material deposition rates and deposition accuracy by using concentric ring wire feed; improved microstructure as a result of using liquid metal coolant; extended capability from near net shape to net shape using integrated milling; assured uniformly dense material (no voids) due to automated inspections and repair. Notwithstanding these improvements to DEMD and the overall benefits of the DEMD process in general, including time, material and energy savings, it has not been accepted by industry as a replacement technology for the manufacture of high value structural components currently being made via forging, casting and rolling. This is due to the fact that DEMD is a gradual process requiring the synchronized interaction of various multivariable functions, any of which can introduce an anomaly into the product, challenging its ability to prove its reliability and repeatability. Prior art does not provide for the comprehensive systems engineering approach necessary to achieve the necessary level of verifiably consistent quality for general acceptance of the process, particularly in aerospace, defense and other critical environments. The current invention defines six major process sub-systems, provides the necessary control features for each sub-system and integrates them with a supervisory controller. The result is a highly automated, interactive process with closed loop control of the entire deposition process and its related subsystems, including the sensing and monitoring of key process characteristics and simultaneous control of multiple independent and dependent variables across multiple subsystems.

System Overview—The Process of the present invention consists of a supervisory controller and six functional sub-systems. The supervisory controller is a software application that runs on a standard personal computer. Its purpose is to establish the overall manufacturing strategy and governs the basic input data that is either passed down to the relevant subsystem in the form of global variables, or is used to derive the necessary dependent sub-system variables. The seven sub-systems, briefly described, are:
1. Geometry Acquisition System (GAPP)—Converts the three dimensional mathematical computer model into two dimensional cross-sections geometry (lines and curves) and imbeds manufacturing strategy information for deposition, machining and inspection processes into the models. Computes numerical control path for each process.
2. Energy Management System (EMS)—Computes and provides the necessary heat input to the melting process and controls the input energy beam characteristics such as power, position, size and shape.
3. Material Deposition System (MDS)—Selects wire size. Computes wire feed rate and table feed rate. Controls the addition of material to the molten pool to achieve near-net shape, including deposition rate and nozzle orientation angles.
4. Integrated Machining System (IMS)—Controls the subtraction of material from each layer to achieve net shape, including cutting tool management and milling/drilling speeds and feeds.
5. Inspection and Repair System (IRS)—Controls the non-destructive inspection of each layer for voids. Controls the excision, re-deposit, re-machining and re-inspection of defective areas.
6. Energy/Mass Transfer Sensor System (EMTSS)—Monitors the rates of energy input, mass transfer, and phase transformation. Its objective is to account for all the energy going into and out of the process in order to maintain a steady state between the molten pool and solidification under varying geometric and microstructural constraints.
7. Heat and Microstructure Management System (HMS)—Controls the removal of excess heat via liquid metal coolant. HMS also helps control material microstructure due to its ability to apply high differential cooling directly to the deposited material. Referring now to FIGS. 6 through 9, the supervisory control consists of a software application that runs on a personal computer; input/output circuit board to gather in-process sensor data and sent parameter adjustment instructions to the various subsystems. Its purpose is to govern the overall manufacturing strategy by collecting basic input data such as material type and temper, layer height, deposition (i.e., near-net shape) parameters (wire diameter, bead width, bead overlap, net excess material), machining parameters (maximum side and end cut loads) and engineered design (i.e., net shape) parameters (geometric tolerances, finish requirements). The software uses standard feedback control mechanisms to monitor and regulate the performance and interaction of the various subsystems.

Supervisory Control: the supervisory control consists of a software application that runs on a personal computer; input/output circuit board to gather in-process sensor data and sent parameter adjustment instructions to the various subsystems. Its purpose is to govern the overall manufacturing strategy by collecting basic input data such as material type and temper, layer height, deposition (i.e., near-net shape) parameters (wire diameter, bead width, bead overlap, net excess material), machining parameters (maximum side and end cut loads) and engineered design (i.e., net shape) parameters (geometric tolerances, finish requirements). The software uses standard feedback control mechanisms to monitor and regulate the performance and interaction of the various subsystems.

Geometry and Path Planning (GAPP)—The GAPP is a software application that runs on a standard personal computer. GAPP automates the geometry acquisition and path planning process. Geometry is acquired through interrogation of a three dimensional computer aided design (CAD) model file that resides in the computer. The CAD model is a true mathematical representation of the object to be created. The GAPP uses “.STL” file formats from one of various off-the-shelf computer aided manufacturing (CAM) applications. It uses the CAD software to create a series of parallel planes equally spaced in accordance with the layer height desired; said planes lie in a direction normal to the direction of layer buildup. The three dimensional model will then be “sliced” by each of the parallel planes, thereby developing a unique cross section in each plane, represented by two sets of contiguous and parallel lines and curves, one representing the outer mold line of the part at that given plane section, at the other representing the inner mold line. GAPP also computes the numerical control path of the inspection head, which approximately follows the path of the centerline between inner and outer mold line geometry.

Energy Management Subsystem (EMS)—The EMS is a software application that runs on a standard personal computer. Its purpose is to control the amount and density of energy being put into the deposition process. The primary objective of EMS is to apply sufficient energy on demand to melt the wire or powder being fed into the molten pool, without introducing excessive heat. The secondary objective of EMS is to shape the beam (and hence the puddle) to control the desired bead width and height. It uses information provided by the supervisory control (melting point, density, latent heat of fusion, specific heat and absorption coefficients) and from the MDS (wire diameter and wire feed rate and translation speed, bead height and bead width) to determine beam parameters, including power, focus length, area and energy density, shape and position.

Material Deposition System (MDS)—The MDS is a software application that runs on a standard personal computer. Its purpose it to control the addition of material to the molten pool to achieve steady state solidification and near-net shape geometry. The MDS controls the deposition rate and nozzle orientation angles. The MDS receives geometry from GAPP. MDS will then calculate the deposition path, based upon desired bead width, bead overlap, and deposit direction (which can be customized on a feature-by-feature basis by embedding vectors in the CAD model). MDS “looks ahead” of the current stage position to compute the next deposition vector tangent from the next stage position (motion vector), and deposition feed rate from the stage velocity vector. Position of wire to molten pool is determined from thermal and optical digital images of the molten pool that are captured using off the shelf software and collimated and superimposed using software that is part of the current invention. Wire position is adjusted through the spool tangent vector (in degrees from 0-360) and nozzle azimuth vector (in degrees from 0-45).

Integrated Machining System (IMS)—The IMS is a software application that runs on a standard personal computer. Its purpose is to control the subtraction of excess material from each layer immediately after deposition in order to achieve net shape. The IMS gets its geometry from GAPP. IMS then selects the proper cutting tools, and milling/drilling speeds and feeds. IMS then computes the machining tool path using previously determined inside and outside mold line contours, and machining parameters. The IMS controls the operation of the milling/drilling head and the motion of the stage during machining. The IMS also changes tools as needed, keeping track of tool wear.

Inspection & Repair System (IRS)—The IRS is a software application that runs on a standard personal computer. Its purpose is to inspect each layer for voids after it is deposited and machined. The IRS controls the operation of the NDI (ultrasonic) head and the motion of the stage during inspection. The IRS records the density at each motion block and stores the block numbers of each block where voids are indicated. Once inspection is complete, the IRS forwards the blocks needing repair to the IMS, which adds ramp down and ramp us blocks to each area requiring excision, then removes the defective areas. The IMS then forwards the blocks containing the excised areas to the MDS. The MDS re-deposits material in the excised area. The IMS then re-machines the areas that were re-deposited, and the IRS then re-inspects the repaired areas. The IMS records all ultrasound readings as part of component certification

Energy/Mass Transfer Sensor System (EMTSS)—The EMTSS is a software application that runs on a standard personal computer. It controls optical and thermal sensors that monitor the energy consumption and phase changes of the material being melted and solidified. The EMTSS software develops a five dimensional thermal map (x,y,z,t,T) of the part that takes into account input energy (from EMS), energy lost to phase transformation (MDS) and other factors in the heat transfer equation, including conduction, radiation and convection (negligible in vacuum). The EMTSS then decides how much heat needs to be removed at each layer and passes that information to the MHS.

Heat and Microstructure Management System (HMS)—The HMS is a software application that runs on a standard personal computer. The HMS' primary objective is to remove excess heat and machine chips from the growing part, which it does by surrounding the part with circulating Liquid Metal Coolant (LMC). The HMS controls the temperature of the LMC by regulating the flow of the LMC through a heat exchanger. The HMS is also responsible for control of the microstructural properties of the deposit through selective cooling, in effect performing heat treatment while the part is being formed. This is possible due to the LMC's ability to remain liquid over a wide temperature range, its high thermal conductivity, and HMS' ability to extract heat quickly, thereby giving it the fast and accurate temperature control necessary to affect the formation of the various phases in eutectic transformations. HMS also controls transducers and the application of sonic frequencies to the built-up or the building layers.

References to the use of electron beam energy sources, wire fed deposition systems, and metallic deposits can be more broadly applied to multiple energy sources (including lasers, plasma torches and arc welders), powder feed systems, and non-metallic compounds on powder or wire form.

Referring now to the drawing, and in particular to FIG. 16, an alternative embodiment is referred to generally by reference numeral 30. Enclosure (vacuum chamber) (1): the process requires a leak-free enclosure in order to prevent oxidation during the deposition process. In the case of electron beam metal deposition (EBMD), which requires a vacuum to operate, the leak-free enclosure is a vacuum chamber, so there is no oxygen to worry about. In non-vacuum systems, the deposition area may be flooded with an inert gas to prevent oxidation. Generally, the vacuum environment produces higher quality welds than inert gas. For metal powder material delivery systems, the inert gas is also used to carry the (metal) powder to the molten pool. An access door is required for inserting and removing components. For EB systems, the chamber is typically made of ½″ to 1″ thick steel, depending on the size of the chamber. Non-vacuum chambers needn't be as thick. [Basic EB welding technology was patented 50 years ago, including gun designs, chambers, pumps etc. No innovations are claimed at this point on any of the mechanical components.

Energy Source (Electron Gun) (2): Numerous energy sources have been used for DEMD, with particular emphasis on lasers. Plasma, arc welders and electron beams have also been used. To be useful in DEMD, the energy source has to have the ability to deliver variable power, typically in the range of 5-50 KW, but scalable depending on requirements. It must deliver the power in a densely focused beam, with a diameter generally ranging from 0.025″ to 0.25″ depending on the desired bead width. The energy source must also have the capability of being controlled in terms of beam power, beam diameter and beam position. The current patent application focuses on EB as the energy source for various reasons, including its superior controllability, scalability, and versatility. The control of the EB (or other energy source), including all of the individual beam parameters, is computer controlled by the Energy Management System (EMS), which is part of the current invention and described in detail under “System Architecture”, below.

Material Feed (Wire Feed): prior art has focused on powder feeders as the pre-deposit material form, primarily because powder is easier to control. However, powder has four serious drawbacks, three economical and one technical. Economically, powder is much more expensive to manufacture than wire, requires an inert carrier gas, cannot be deposited in as high a volume as powder, and a significant portion of it is wasted in the process (up to 50%, depending on the process particulars) because whatever powder does not get fused in the molten pool cannot be reused because of contamination. Wire, by contrast, is cheaper to produce, requires no carrier gas, and produces virtually no waste. Technically, powder does not fuse as reliably as wire, because some of the powder is melted at the fringe of the molten pool, and is potentially incompletely melted before solidification takes place. Wire, by contrast, can be directed to the center of the molten pool, thereby ensuring its complete fusion. If the wire doesn't melt, it becomes very obvious—the wire becomes “stuck” and the wire feeder stops. The current design enables the rapid and accurate orientation, placement, and deposition of wire, as described below.

The Electron Beam (3) impinges on a substrate (4), typically a sacrificial metal plate approximately similar in chemical composition to the alloy being deposited, but may be actual material that becomes part of the final deposited component configuration. The beam's energy is absorbed by the material, thereby creating a small molten pool, about the size of the beam's diameter, at the surface of the substrate. The substrate is translated in the plane of deposition by synchronously controlled X drive (23) and Y drive (24) motors. Material is fed into the molten pool by a wire feeder (5) or powder feeder that delivers material in the form of wire or powder, respectively, to the pool at a variable rate. The current design is unique and distinct from prior art because it enables continuous 360 degree rotation of the wire feeder, without its becoming obstructed or limited or entangled by the wire feed path. This is possible because the wire feed spool (6) is mounted on a carriage (7), both of which are free to rotate about an axis collinear with the axis of the beam; hence, the beam passes through the center of the spool and a corresponding hole in the carriage. The base of the carriage is mounted to a ring gear (8), also concentric to the beam, which is meshed to a drive gear (9) powered by a step motor (10). The carriage is located on and rotates about a threaded spindle (11) which consists of a cylinder welded to an annular ring, both of whose axes are concentric with the axis of the beam. The spindle mounts to the chamber ceiling. A thrust ring (12) is threaded about the end of the spindle protruding through the hole in the carriage, holding the carriage in place. An upper thrust bearing (13) is seated between the ring gear and the annular plate of the spindle. A lower thrust bearing (14) is seated between the thrust ring and the carriage's spool-locating cylinder. A ring gear roller bearing (not shown) is located between the ring gear and spindle shaft to support radial loads.

Integrated Machining Device: once the wire is melted into a near net shape layer, the final configuration is established using a retractable finishing arm (15) with a milling/drilling head (16) attached. The retractable arm is hydraulically or electrically powered telescoping arm that is mounted to the side of the chamber. A mill/drill head is attached to the end of the arm. The arm extends horizontally such that the centerline of the mill or drill is collinear with the beam axis. The advantage of integrated milling is that it enables the creation of net shape deposition, thereby eliminating the need for post deposition machining. It also simplifies the metal removal process by having it occur when the excess material is readily accessible and can be removed quickly. It also enables the ability to accurately create hollow cross sections that cannot otherwise be created without the use of laborious and expensive investment casting. It also reduces the complexity of the machining process to a simple two axis process involving minimal material removal, thereby requiring much less expensive equipment occupying less space (e.g., a router type head versus a major machine tool), less set-ups, less time and less potential for error. The finish machining is performed under the control of the Integrated Machining System.

Inspection and Repair Device: a retractable inspection arm (not shown), similar in design to the retractable machining arm, is mounted to the opposite side wall of the chamber. Attached to the end of the arm is a non-destructive inspection (NDI) device, typically an ultrasonic signal-emitting density-sensing device, capable of detecting voids, thereby enabling efficient, accurate layer-by layer detection and mapping of flaws. The integration of NDI into the manufacturing process provides many benefits. As previously discussed, casting and forging are batch processes, i.e., the part is made all at once from a single “pour” of metal. This creates a situation where imperfections can get buried in the middle of the casting or forging, rendering the flaws hard to detect and even more difficult (and expensive and time consuming) to repair. Similarly, previous metal deposition systems that don't have integrated machining capabilities also have the potential to introduce flaws. In the current invention, once the flaw is detected, it is quickly excised with the milling head, material is re-deposited, and re-machined and re-inspected. The inspection and repair is performed under the automated control of the Inspection and Repair System (IRS) software, part of the current invention.

Heat sink: all DEMD systems produce a certain amount of excess heat. As the number of deposited layers grows, the heat builds, which weakens the surface tension of the molten pool and negatively effects deposition control. The inability to remove the heat quickly and efficiently also has negative effects on the microstructure and the rate of deposit. Prior art provides for cooling by conduction through a water-cooled platen (usually copper), or by convection via inert gas. The current process of the present invention uses a specially formulated liquid metal coolant (“LMC”), an alloy specially developed for this process comprised predominantly of tin, gallium, indium and silver that remains in a liquid state over a wide temperature range (100° C. 1,000° C.). The LMC circulates through a vat (17) containing the part (18), which rests on a working platform (19) supported by a hydraulic actuator (20) that gradually lowers as the deposited layers build, thereby keeping all but the most recently build layer submerged in the LMC. The LMC enters the vat through one or more in-flow ports (21) in the side wall located neat the top of the vat and exits through one or more out-flow ports (22) in the side wall located near the bottom of the vat. Computer controlled valves and pumps are used to cycle the liquid metal through a heat exchanger (e.g. water chiller) at the appropriate rate to maintain the desired cooling profile. The LMC, which has high thermal conductivity, remains in a liquid state over a wide temperature range (approx. 100-1000 degrees C.), thereby providing the ability to remove heat rapidly and precisely over a wide temperature range, thereby allowing unprecedented control over metallurgical microstructure.

System Architecture: the previously described innovations offer significant improvements to the DEMD process: improved material deposition rates and deposition accuracy by using concentric ring wire feed; improved microstructure as a result of using liquid metal coolant; extended capability from near net shape to net shape using integrated milling; assured uniformly dense material (no voids) due to automated inspections and repair. Notwithstanding these improvements to DEMD and the overall benefits of the DEMD process in general, including time, material and energy savings, it has not been accepted by industry as a replacement technology for the manufacture of high value structural components currently being made via forging, casting and rolling. This is due to the fact that DEMD is a gradual process requiring the synchronized interaction of various multivariable functions, any of which can introduce an anomaly into the product, challenging its ability to prove its reliability and repeatability. Prior art does not provide for the comprehensive systems engineering approach necessary to achieve the necessary level of verifiably consistent quality for general acceptance of the process, particularly in aerospace, defense and other critical environments. The current invention defines six major process sub-systems, provides the necessary control features for each sub-system and integrates them with a supervisory controller. The result is a highly automated, interactive process with closed loop control of the entire deposition process and its related subsystems, including the sensing and monitoring of key process characteristics and simultaneous control of multiple independent and dependent variables across multiple subsystems.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A system for working on a substrate
a generator for focusing a directed energy beam onto the substrate;
a three axis stage; and
a controller capable of accommodating two additional rotational axes.

2. A system according to claim 1, wherein the directed energy beam is an electronic beam.

3. A system according to claim 1 wherein the directed energy beam is a laser.

4. A system according to claim 1 further including a spindle for dispensing a wire from a spool to be melted by the directed energy beam, creating a workpiece.

5. A system according to claim 4 further including a machining tool for working on the workpiece as it is created.

6. A system according to claim 5 wherein the spindle and the machining tool move together with respect to the workpiece.
